(19) United States
(12) Patent Application Publication
(10) Pub. No.: US 2026/0318478 A1
(43) Pub. Date: Oct. 15, 2026

(54) LUBRICATION SYSTEM FOR LUBRICATING LOWER SUB ADAPTOR OF DRILLING MACHINE

(71) Applicant: Caterpillar Global Mining Equipment LLC., Denison, TX (US)

(72) Inventors: Sarathkumar Kumaraswamy, Chennai (IN); Ashok Kumar Natarajan, Chennai (IN)

(73) Assignee: Caterpillar Global Mining Equipment LLC., Denison, TX (US)

(21) Appl. No.: 19/175,038

(22) Filed: Apr. 10, 2025

(51) Int. Cl. F16N 25/00; E21B 12/00

(52) U.S. Cl. CPC F16N 25/00; E21B 12/00; F16N 2210/26

(57) ABSTRACT

A lubrication system for lubricating one or more internal threads of a lower sub adaptor of a drilling machine includes a bracket removably coupled with an automatic bit changer associated with the drilling machine. The bracket includes a first surface and a second surface opposite the first surface. The bracket defines a through-opening extending between the first surface and the second surface. The lower sub adaptor is adapted to engage with the bracket. The lubrication system also includes a mounting assembly coupled with the bracket at the second surface of the bracket. The lubrication system further includes a nozzle coupled with the mounting assembly. At least a portion of the nozzle is received within the through-opening in the bracket. The nozzle is adapted to spray a flow of lubricant towards the one or more internal threads of the lower sub adaptor via the through-opening in the bracket.

### TECHNICAL FIELD

The present disclosure relates to an automatic bit changer for a drilling machine, a lubrication system for lubricating a lower sub adaptor of the drilling machine, and a method for lubricating the lower sub adaptor of the drilling machine.

### BACKGROUND

A drilling machine includes a drill string having a work tool for performing drilling operations at a worksite. The drill string includes one or more connected drill pipes, a lower sub adaptor, and the work tool which is connected to a bottom of a formation. The lower sub adaptor includes internal threads that engage with external threads of the work tool to couple the lower sub adaptor with the work tool. The work tool may include a rotary drill bit or a down-the-hole drill bit. The drilling machine further includes an automatic bit changer to automatically change the work tool during a drilling operation as per requirements. The automatic bit changer holds one or more work tools therein.

Typically, before engaging a new work tool with the lower sub adaptor, a lubricant such as grease is needed on the internal threads of the lower sub adaptor and/or on the external threads of the work tool for smooth handling and coupling. However, an absence of the lubricant may cause corrosion, may create difficulty in coupling the work tool with the lower sub adaptor, and may affect a life of the lower sub adaptor and/or the work tool. Conventionally, an operator manually lubricates the internal threads of the lower sub adaptor and/or the external threads of the work tool that results in downtime of the drilling machine and also involves additional human efforts, which is not desirable.

CN215632840U describes a drill rod storage mechanism and a punching drilling machine, a drill rod is of a hollow structure, threads are arranged on the inner side face of the end of the drill rod, the drill rod storage mechanism comprises a rod bin used for storing the drill rod, the rod bin comprises a rotating shaft and a rotating disc, the rotating disc is arranged on the rotating shaft in a sleeved mode, and the rotating shaft drives the rotating disc to rotate. A notch is formed in the edge of the rotary disc, and the drill rod is clamped into the notch. And the spraying device is arranged on the outer side of the end face of the rod bin, the position of the spraying device corresponds to the position of the through hole, and when the drill rod rotates to the position of the through hole, the spraying device sprays lubricating oil to threads in the drill rod. After the drill rods are used up and taken back, before next drilling and when each drill rod rotates to the position of a through hole, new lubricating oil is automatically added to the threads of the drill rods by the spraying device, so that the drill rods are prevented from being abraded, dust is blocked, manual operation is not needed, the safety of an operator is guaranteed, and meanwhile, more convenience and rapidness are achieved.

### SUMMARY OF THE DISCLOSURE

In an aspect of the present disclosure, a lubrication system for lubricating a lower sub adaptor of a drilling machine is provided. The lower sub adaptor includes one or more internal threads. The lubrication system includes a bracket removably coupled with an automatic bit changer associated with the drilling machine. The bracket includes a first surface and a second surface opposite the first surface. The bracket defines a through-opening extending between the first surface and the second surface. The lower sub adaptor is adapted to engage with the bracket. The lubrication system also includes a mounting assembly coupled with the bracket at the second surface of the bracket. The lubrication system further includes a nozzle coupled with the mounting assembly. At least a portion of the nozzle is received within the through-opening in the bracket. The nozzle is adapted to spray a flow of lubricant towards the one or more internal threads of the lower sub adaptor via the through-opening in the bracket.

In another aspect of the present disclosure, an automatic bit changer for a drilling machine is provided. The drilling machine includes a lower sub adaptor including one or more internal threads. The automatic bit changer includes a housing adapted to store a plurality of work tools. The automatic bit changer also includes a lid pivotally coupled with the housing and adapted to enclose the plurality of work tools within the housing. The automatic bit changer further includes a lubrication system for lubricating the lower sub adaptor. The lubrication system includes a bracket removably coupled with the housing. The bracket includes a first surface and a second surface opposite the first surface. The bracket defines a through-opening extending between the first surface and the second surface. The lower sub adaptor is adapted to engage with the bracket. The lubrication system also includes a mounting assembly coupled with the bracket at the second surface of the bracket. The lubrication system further includes a nozzle coupled with the mounting assembly. At least a portion of the nozzle is received within the through-opening in the bracket. The nozzle is adapted to spray a flow of lubricant towards the one or more internal threads of the lower sub adaptor via the through-opening in the bracket.

In yet another aspect of the present disclosure, a method for lubricating a lower sub adaptor of a drilling machine is provided. The method includes providing an automatic bit changer associated with the drilling machine. The method also includes rotating the automatic bit changer in an angular direction to a bit changing position. The method further includes rotating the lower sub adaptor relative to a vertical axis of the drilling machine. The lower sub adaptor includes one or more internal threads. The method includes engaging the lower sub adaptor with a bracket of a lubrication system. The bracket is removably coupled with the automatic bit changer. The bracket includes a first surface and a second surface opposite the first surface. The bracket defines a through-opening extending between the first surface and the second surface. The method also includes spraying, via a nozzle of the lubrication system, a flow of lubricant towards the one or more internal threads of the lower sub adaptor via the through-opening in the bracket. The nozzle is coupled with the bracket via a mounting assembly of the lubrication system. At least a portion of the nozzle is received within the through-opening in the bracket.

Other features and aspects of this disclosure will be apparent from the following description and the accompanying drawings.

### BRIEF DESCRIPTION OF THE DRAWINGS

FIG. 1 is a schematic side view of a drilling machine, according to an example of the present disclosure;

FIG. 2 is a cross-sectional side view of an automatic bit changer of the drilling machine of FIG. 1, according to an example of the present disclosure;

FIG. 3 is a schematic perspective view of the automatic bit changer of FIG. 2;

FIG. 4A is a schematic perspective view of a portion of the automatic bit changer of FIG. 3;

FIG. 4B is a schematic perspective view of a portion of the automatic bit changer of FIG. 3; and

FIG. 5 is a flowchart of a method for lubricating the lower sub adaptor of the drilling machine of FIG. 1, according to an example of the present disclosure.

### DETAILED DESCRIPTION

Wherever possible, the same reference numbers will be used throughout the drawings to refer to the same or like parts.

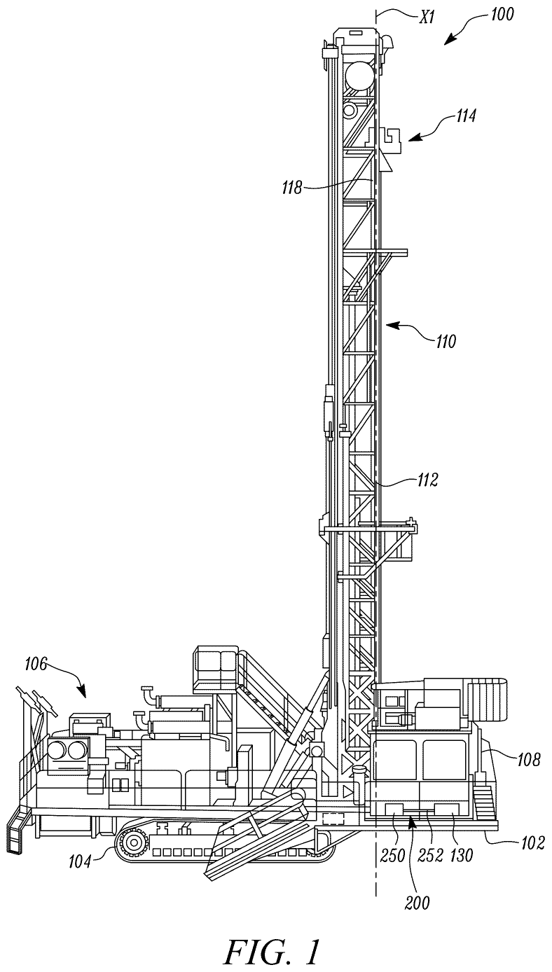

Referring to FIG. 1, a schematic side view of an exemplary drilling machine 100 is illustrated. In the illustrated example of FIG. 1, the drilling machine 100 is a rotary drilling machine. However, the drilling machine 100 may embody any other type of drilling machine, without any limitations. The drilling machine 100 may be a manual, an autonomous, or a semi-autonomous work machine. The drilling machine 100 may be used to perform one or more drilling operations, such as drilling holes, mining blast holes, geothermal wells, and the like. The drilling machine 100 defines a vertical axis X1.

As shown in FIG. 1, the drilling machine 100 includes a frame 102. The frame 102 may be supported on a ground surface by a transport mechanism, such as crawler tracks 104. The crawler tracks 104 may allow the drilling machine 100 to maneuver on ground surfaces to a desired location for performing drilling operations. Alternatively, the drilling machine 100 may include wheels instead of the crawler tracks 104. The frame 102 includes one or more jacks (not shown herein) for supporting and leveling the drilling machine 100 on the ground surface during drilling operations.

The drilling machine 100 also includes a machinery 106. The frame 102 may support the machinery 106, which may include various components (not shown), such as, a power source (not shown), for example, an engine, a battery system, and/or a fuel system, motors, pumps, air compressors, and/or any other equipment necessary to supply power to operate the drilling machine 100. The frame 102 further supports an operator cabin 108, from which an operator may maneuver and control the drilling machine 100.

The drilling machine 100 includes a mast system 110 supported on the frame 102. The mast system 110 extends along the vertical axis X1. The mast system 110 includes a mast weldment 112 coupled to the frame 102.

The drilling machine 100 further includes a drill head 114 movable relative to the mast system 110. The drill head 114 is movable along the vertical axis X1 and is supported on the mast system 110. The machinery 106 may provide power to operate the drill head 114 relative to the mast system 110. In some examples, the drilling machine 100 may include one or more motors (not shown) associated with the drill head 114.

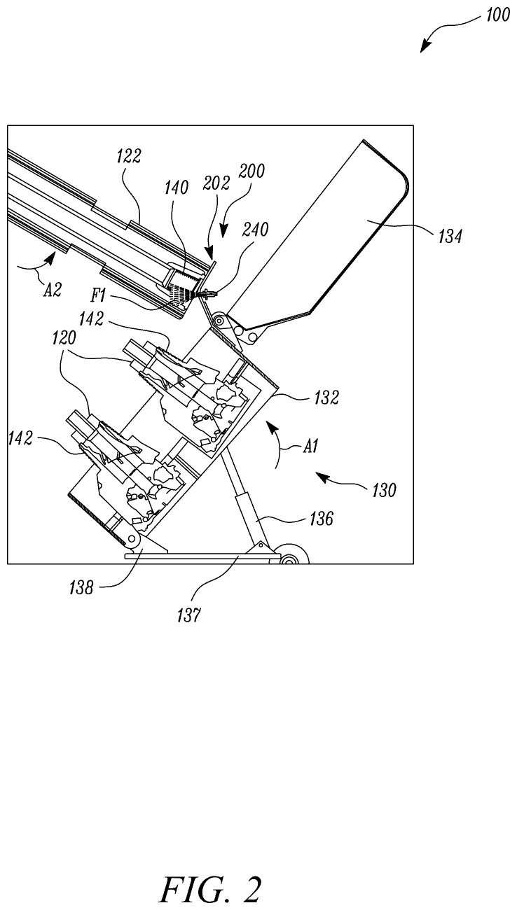

The drilling machine 100 includes a drill string 118. The drill head 114 may support the drill string 118. The drill head 114 may couple to, and rotate, the drill string 118 for performing the drilling operation. The drilling machine 100 also includes a lower sub adaptor 122 (shown in FIG. 2). The lower sub adaptor 122 includes one or more internal threads 140 (shown in FIG. 2). The internal threads 140 of the lower sub adaptor 122 engage with one or more external threads 142 of a work tool 120 (shown in FIG. 2), thereby coupling the lower sub adaptor 122 with the work tool 120. The work tool 120 may allow drilling into various surfaces. The work tool 120 may include a rotary drill bit or a down-the-hole (DTH) drill bit.

The drilling machine 100 further includes an automatic bit changer 130. The automatic bit changer 130 is used to automatically couple a particular work tool, such as the work tool 120, with the lower sub adaptor 122 as per requirements.

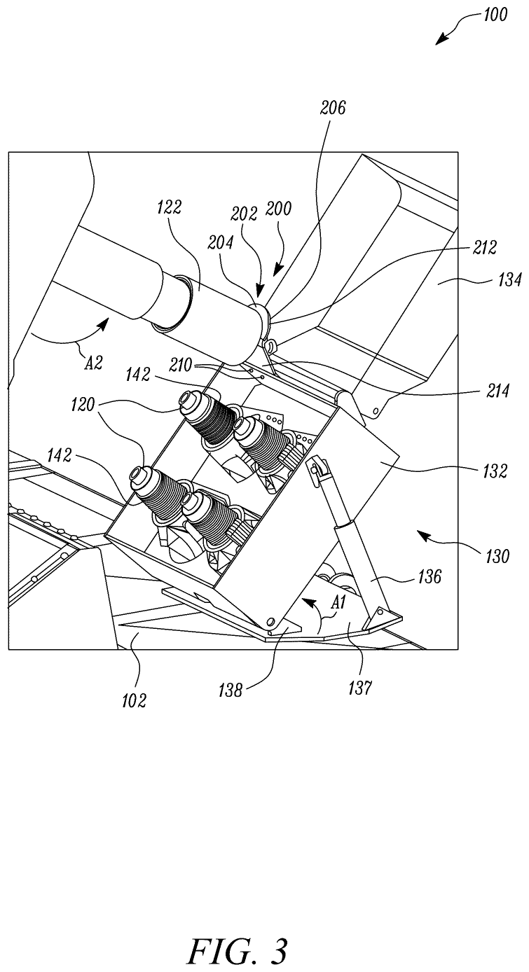

Referring to FIGS. 2 and 3, the automatic bit changer 130 includes a housing 132 to store a number of work tools 120. The number of work tools 120 may be of same type or may be of different types. In the illustrated example of FIG. 3, the housing 132 is square in shape. In some examples, the housing 132 may be rectangular in shape, circular in shape, and the like, without any limitations. Further, in the illustrated example of FIGS. 2 and 3, the housing 132 stores four work tools 120. Alternatively, the housing 132 may store any number of work tools 120 as per application attributes. Each work tool 120 from the number of work tools 120 is embodied as the rotary drill bit. Alternatively, the work tool 120 may embody the DTH drill bit. The automatic bit changer 130 also includes a lid 134 pivotally coupled with the housing 132 and encloses the number of work tools 120 within the housing 132. The automatic bit changer 130 may include one or more actuators (not shown) that may rotate the lid 134 between an open position and a closed position.

The automatic bit changer 130 also includes a base plate 137 coupled with the frame 102 and a coupling bracket 138 coupled with the base plate 137. The housing 132 is pivotably coupled with the pair of coupling brackets 138. The bracket 138 may pivot the housing 132 relative to the base plate 137.

The automatic bit changer 130 further includes one or more actuators 136 coupled with the housing 132. Specifically, the automatic bit changer 130 includes a pair of actuators 136 (only one of which is shown in FIGS. 2 and 3). The one or more actuators 136 are coupled to the housing 132 at one end and with the base plate 137 at another end. In some examples, the one or more actuators 136 may be a pneumatic actuator, a hydraulic actuator, a hydraulic motor, an electric actuator, and the like, without limiting the scope of the present disclosure.

The one or more actuators 136 rotate the automatic bit changer 130 in an angular direction A1. Specifically, the one or more actuators 136 rotate the housing 132 of the automatic bit changer 130 angularly towards a bit changing position. When disposed in the bit changing position, the work tool 120 may be assembled or disassembled from the lower sub adaptor 122. The one or more actuators 136 may rotate the automatic bit changer 130 by an angle that may lie in a range of 20 degrees to 80 degrees.

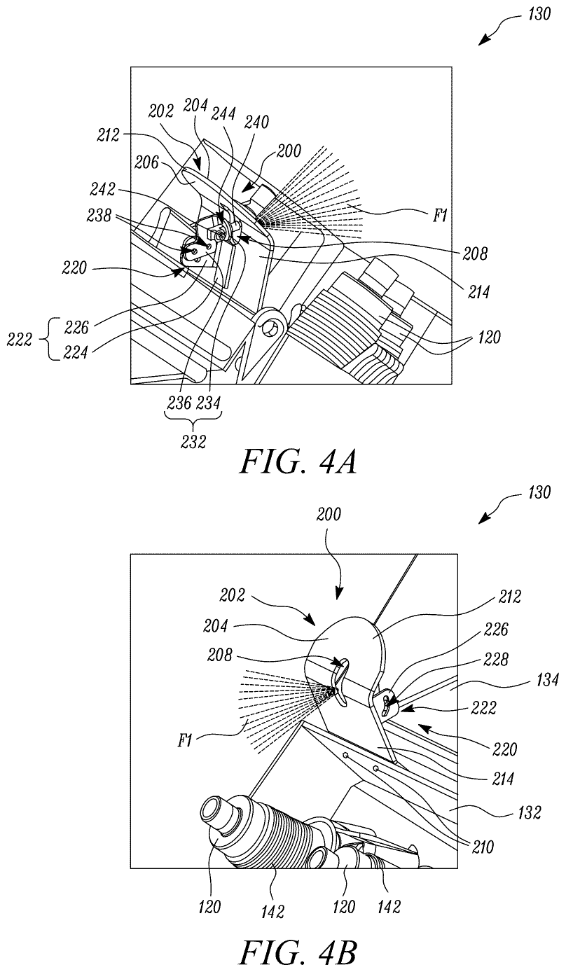

With reference to FIGS. 4A and 4B, the automatic bit changer 130 further includes a lubrication system 200 for lubricating the lower sub adaptor 122. The lubrication system 200 includes a bracket 202 removably coupled with the housing 132. The lubrication system 200 further includes one or more fastening means 210 that removably couple the bracket 202 with the housing 132. In some examples, the bracket 202 may be coupled with the housing 132 using any known fastening means, such as, bolts, screws, rivets, and the like. Alternatively, the bracket 202 may be coupled with the housing 132 by a snap fit mechanism, a push fit mechanism, and the like. In other examples, the bracket 202 may be fixedly coupled with the housing 132 for example via welding, soldering or brazing. In some examples, the bracket 202 may be made of a metal, a polymer, an alloy, and the like.

The bracket 202 includes a first surface 204 and a second surface 206 opposite the first surface 204. The bracket 202 of the lubrication system 200 further includes a first member 212 and a second member 214 that is integral with the first member 212. The first member 212 extends angularly relative to the second member 214. The first surface 204 and the second surface 206 is together defined by the first member 212 and the second member 214.

The bracket 202 defines a through-opening 208 extending between the first surface 204 and the second surface 206. Specifically, the through-opening 208 is at least partially defined in each of the first member 212 and the second member 214. In the illustrated example of FIG. 4B, the through-opening 208 is elliptical in shape. In some examples, the through-opening 208 may be circular in shape, rectangular in shape, square in shape, oval in shape, and the like, without any limitations.

The lubrication system 200 also includes a mounting assembly 220 coupled with the bracket 202 at the second surface 206 of the bracket 202. The mounting assembly 220 includes a first plate 222 fixedly coupled with the second surface 206 of the bracket 202. Specifically, the first plate 222 is fixedly coupled with the second member 214 of the bracket 202.

The first plate 222 includes a first portion 224 and a second portion 226 extending from the first portion 224. The first portion 224 is fixedly coupled with the second surface 206 of the bracket 202. In an example, the first portion 224 may be fixedly coupled with the second surface 206 of the bracket 202 via welding, soldering, brazing, and the like. Alternatively, the first portion 224 may be removably coupled with the second surface 206 using any known fastening means, such as, bolts, screws, rivets, and the like. The second portion 226 defines a groove 228.

The mounting assembly 220 also includes a second plate 232 removably coupled with the first plate 222. Specifically, the second plate 232 is pivotably coupled with the first plate 222. The second plate 232 includes a first portion 234 and a second portion 236 extending from the first portion 234. Specifically, the second portion 236 extends angularly from the first portion 234. The first portion 234 defines a through-hole 244. The second portion 236 defines one or more holes 238. In the illustrated example of FIGS. 4A and 4B, the second portion 236 defines a pair of holes 238. The groove 228 of the second portion 226 of the first plate 222 aligns with a corresponding hole 238 defined in the second portion 236 of the second plate 232 to receive a pin (not shown). Specifically, the pin pivotably couples the first plate 222 with the second plate 232.

The lubrication system 200 further includes a nozzle 240 coupled with the mounting assembly 220. The nozzle 240 is received into the through-hole 244 of the first portion 234 of the second plate 232. Further, at least a portion of the nozzle 240 is received within the through-opening 208 in the bracket 202. The nozzle 240 includes an inlet 242.

The lubrication system 200 includes a tank 250 (shown in FIG. 1) to store the lubricant. In some examples, the lubricant may be grease, oil, and the like. The tank 250 is disposed on the frame 102 (see FIGS. 1 and 3) of the drilling machine 100. The lubrication system 200 also includes a hose 252 (see FIG. 1) that fluidly couples the tank 250 with the nozzle 240. Specifically, the hose 252 allows the lubricant to flow towards the inlet 242 of the nozzle 240, from the tank 250.

During an operation, the nozzle 240 sprays a flow F1 of lubricant towards the one or more internal threads 140 (see FIG. 2) of the lower sub adaptor 122 (see FIG. 2) via the through-opening 208 in the bracket 202.

With reference to FIGS. 2 to 4B, in an example, to engage the lower sub adaptor 122 with the bracket 202, the automatic bit changer 130 is rotated to the bit changing position via the one or more actuators 136 followed by the rotation of the lower sub adaptor 122 relative to the vertical axis X1. Specifically, the lower sub adaptor 122 is rotated in a direction A2 until the lower sub adaptor 122 may rest on the first member 212 of the bracket 202. In some examples, the lower sub adaptor 122 may be rotated in the direction A2 by an angle that may be in a range of 20 degrees to 90 degrees. Upon engagement of the lower sub adaptor 122 with the first member 212 of the bracket 202, a user may actuate the nozzle 240 to spray the flow F1 of lubricant towards the one or more internal threads 140 of the lower sub adaptor 122. In some examples, the nozzle 240 may be actuated automatically for example, via a control system. In some examples, since the second plate 232 is pivotably coupled with the first plate 222, the user may adjust a direction of the nozzle 240 to spray the flow F1 of the lubricant towards the internal threads 140.

Further, after spraying the flow F1 of the lubricant towards the one or more internal threads 140 of the lower sub adaptor 122 by the nozzle 240, the lower sub adaptor 122 may be brought closer to the work tool 120 such that some portion of the lubricant may flow towards the external threads 142 of the work tool 120. The lower sub adaptor 122 may then be coupled with a corresponding work tool 120 from the number of work tools 120.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the lubrication system 200 associated with the automatic bit changer 130 for lubricating the internal threads 140 of the lower sub adaptor 122 of the drilling machine 100. The lubrication system 200 includes the bracket 202 and the nozzle 240 coupled with the bracket 202 via the mounting assembly 220. The nozzle 240 sprays the flow F1 of lubricant towards the one or more internal threads 140 of the lower sub adaptor 122 via the through-opening 208 in the bracket 202 and also allows lubrication of the external threads 142 of the work tool 120.

The nozzle 240 may evenly distribute the lubricant all over the internal threads 140 of the lower sub adaptor 122, thereby eliminating uneven distribution and application of the lubricant which is otherwise possible when the lubrication is done manually. Further, the lubrication system 200 may improve a run time of the drilling machine 100. The lubrication system 200 is cost-effective as the lubrication system 200 does not include any costly components. Further, the lubrication system 200 may eliminate a requirement of a personnel or operator to manually perform a lubrication process.

Further, the groove 228 defined in the first plate 222 may result in a pivoting motion of the second plate 232 relative to the first plate 222 and may allow the nozzle 240 to change the direction of flow F1 of the lubricant. Furthermore, the pair of holes 238 defined in the second plate 232 may allow the second plate 232 to be pivotably coupled with the first plate 222 at two different locations resulting in two different orientations of the nozzle 240.

Overall, the lubrication system 200 may be simple in construction, may be cost-effective, and may be durable. Further, the lubrication system 200 may be retrofitted on existing automatic bit changers. Moreover, the lubrication system 200 may be used on a variety of automatic bit changers. The lubrication system 200 described herein may reduce corrosion of the lower sub adaptor 122 and the work tools 120 by providing sufficient lubrications, may allow easy coupling of the work tool 120 with the lower sub adaptor 122, and may improve a life of the lower sub adaptor 122 and the work tool 120.

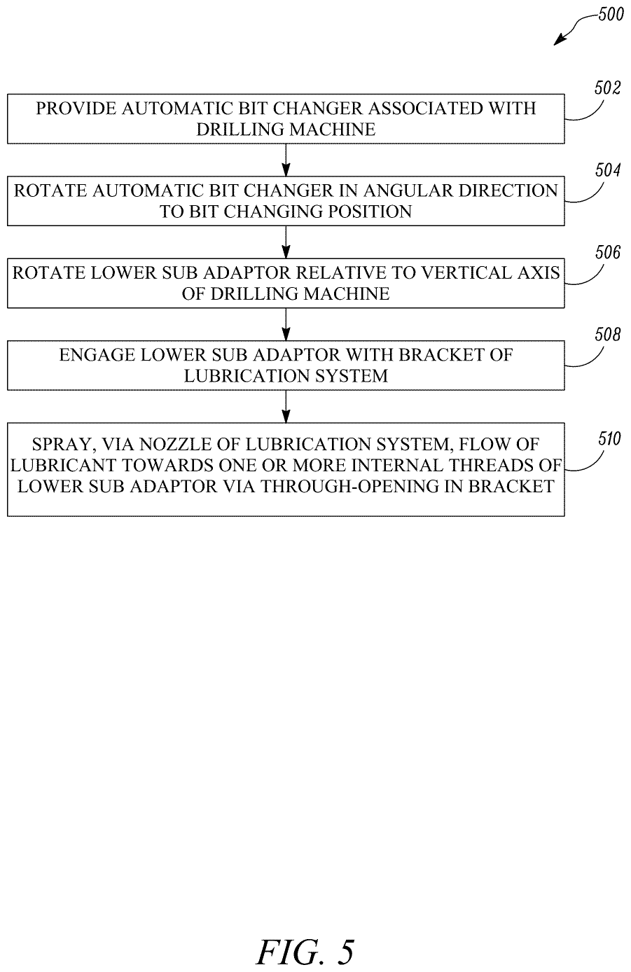

FIG. 5 is a flowchart of a method 500 for lubricating the lower sub adaptor 122 of the drilling machine 100. Referring to FIGS. 1 to 5, at step 502, the automatic bit changer 130 associated with the drilling machine 100 is provided.

At step 504, the automatic bit changer 130 is rotated in the angular direction A1 to the bit changing position. The step 504 further includes rotating the housing 132 of the automatic bit changer 130 in the angular direction A1 to the bit changing position.

At step 506, the lower sub adaptor 122 is rotated relative to the vertical axis X1 of the drilling machine 100. The lower sub adaptor 122 includes the one or more internal threads 140.

At step 508, the lower sub adaptor 122 is engaged with the bracket 202 of the lubrication system 200. The bracket 202 is removably coupled with the automatic bit changer 130. The bracket 202 includes the first surface 204 and the second surface 206 opposite the first surface 204. The bracket 202 defines the through-opening 208 extending between the first surface 204 and the second surface 206.

At step 510, the flow F1 of lubricant is sprayed via the nozzle 240 of the lubrication system 200 towards the one or more internal threads 140 of the lower sub adaptor 122 via the through-opening 208 in the bracket 202. The nozzle 240 is coupled with the bracket 202 via the mounting assembly 220 of the lubrication system 200. At least the portion of the nozzle 240 is received within the through-opening 208 in the bracket 202. The lubrication system 200 further includes the tank 250 to store the lubricant and the hose 252 that fluidly couples the tank 250 with the nozzle 240. The tank 250 is disposed on the frame 102 of the drilling machine 100. The step 510 further includes actuating the nozzle 240 by the user to spray the flow F1 of lubricant towards the one or more internal threads 140 of the lower sub adaptor 122.

The method 500 further includes a step (not shown) at which the lower sub adaptor 122 is coupled with the work tool 120 from the number of work tools 120 upon spraying the flow F1 of lubricant towards the one or more internal threads 140 of the lower sub adaptor 122 by the nozzle 240. The number of work tools 120 are stored in the housing 132 of the automatic bit changer 130.

It should be noted that the steps 502, 504, 506, 508, 510 of the method 500 may be performed in a sequence that is different from that explained in relation to FIG. 5. Further, various steps 502, 504, 506, 508, 510 can be performed together.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

1. A lubrication system for lubricating a lower sub adaptor of a drilling machine, the lower sub adaptor including one or more internal threads, the lubrication system comprising:
a bracket removably coupled with an automatic bit changer associated with the drilling machine, wherein the bracket includes a first surface and a second surface opposite the first surface, wherein the bracket defines a through-opening extending between the first surface and the second surface, and wherein the lower sub adaptor is adapted to engage with the bracket;
a mounting assembly coupled with the bracket at the second surface of the bracket; and
a nozzle coupled with the mounting assembly, wherein at least a portion of the nozzle is received within the through-opening in the bracket, and wherein the nozzle is adapted to spray a flow of lubricant towards the one or more internal threads of the lower sub adaptor via the through-opening in the bracket.

2. The lubrication system of claim 1, wherein the mounting assembly includes:
a first plate fixedly coupled with the second surface of the bracket; and
a second plate removably coupled with the first plate, wherein the nozzle is coupled with the second plate.

3. The lubrication system of claim 1 further comprising one or more fastening means that is adapted to removably couple the bracket with the automatic bit changer.

4. The lubrication system of claim 1 further comprising a tank adapted to store lubricant and a hose that fluidly couples the tank with the nozzle, wherein the tank is disposed on a frame of the drilling machine.

5. The lubrication system of claim 1, wherein the bracket further includes a first member and a second member that is integral with the first member, and wherein the first member extends angularly relative to the second member.

6. The lubrication system of claim 5, wherein the lower sub adaptor is adapted to engage with the first member of the bracket.

7. The lubrication system of claim 5, wherein the through-opening is at least partially defined in each of the first member and the second member.

8. An automatic bit changer for a drilling machine, the drilling machine including a lower sub adaptor including one or more internal threads, the automatic bit changer comprising:
a housing adapted to store a plurality of work tools;
a lid pivotally coupled with the housing and adapted to enclose the plurality of work tools within the housing; and
a lubrication system for lubricating the lower sub adaptor, the lubrication system including:
a bracket removably coupled with the housing, wherein the bracket includes a first surface and a second surface opposite the first surface, wherein the bracket defines a through-opening extending between the first surface and the second surface, and wherein the lower sub adaptor is adapted to engage with the bracket;
a mounting assembly coupled with the bracket at the second surface of the bracket; and
a nozzle coupled with the mounting assembly, wherein at least a portion of the nozzle is received within the through-opening in the bracket, and wherein the nozzle is adapted to spray a flow of lubricant towards the one or more internal threads of the lower sub adaptor via the through-opening in the bracket.

9. The automatic bit changer of claim 8 further comprising one or more actuators coupled with the housing, wherein the one or more actuators are adapted to rotate the housing angularly towards a bit changing position.

10. The automatic bit changer of claim 8, wherein, to engage the lower sub adaptor with the bracket, the lower sub adaptor is adapted to rotate relative to a vertical axis of the drilling machine.

11. The automatic bit changer of claim 8, wherein the mounting assembly of the lubrication system includes:
a first plate fixedly coupled with the second surface of the bracket;
and a second plate removably coupled with the first plate, wherein the nozzle is coupled with the second plate.

12. The automatic bit changer of claim 8, wherein the lubrication system includes a tank adapted to store lubricant and a hose that fluidly couples the tank with the nozzle, and wherein the tank is disposed on a frame of the drilling machine.

13. The automatic bit changer of claim 8, wherein the bracket of the lubrication system further includes a first member and a second member that is integral with the first member, and wherein the first member extends angularly relative to the second member.

14. The automatic bit changer of claim 13, wherein the lower sub adaptor is adapted to engage with the first member of the bracket.

15. The automatic bit changer of claim 13, wherein the through-opening is at least partially defined in each of the first member and the second member.

16. The automatic bit changer of claim 8, wherein the lubrication system further includes one or more fastening means that removably couples the bracket with the housing.

17. A method for lubricating a lower sub adaptor of a drilling machine, the method comprising:
providing an automatic bit changer associated with the drilling machine;
rotating the automatic bit changer in an angular direction to a bit changing position;
rotating the lower sub adaptor relative to a vertical axis of the drilling machine, wherein the lower sub adaptor includes one or more internal threads;
engaging the lower sub adaptor with a bracket of a lubrication system, wherein the bracket is removably coupled with the automatic bit changer, wherein the bracket includes a first surface and a second surface opposite the first surface, and wherein the bracket defines a through-opening extending between the first surface and the second surface; and
spraying, via a nozzle of the lubrication system, a flow of lubricant towards the one or more internal threads of the lower sub adaptor via the through-opening in the bracket, wherein the nozzle is coupled with the bracket via a mounting assembly of the lubrication system, and wherein at least a portion of the nozzle is received within the through-opening in the bracket.

18. The method of claim 17, wherein the step of rotating the automatic bit changer in the angular direction to the bit changing position further includes rotating a housing of the automatic bit changer in the angular direction to the bit changing position.

19. The method of claim 18 further comprising a step of coupling the lower sub adaptor with a work tool from a plurality of work tools upon spraying, by the nozzle, the flow of lubricant towards the one or more internal threads of the lower sub adaptor, wherein the plurality of work tools are stored in the housing of the automatic bit changer.

20. The method of claim 17, wherein the lubrication system further includes a tank adapted to store lubricant and a hose that fluidly couples the tank with the nozzle, wherein the tank is disposed on a frame of the drilling machine, and wherein the step of spraying, via the nozzle of the lubrication system, the flow of lubricant towards the one or more internal threads of the lower sub adaptor further includes actuating the nozzle, by a user, to spray the flow of lubricant towards the one or more internal threads of the lower sub adaptor.
